(19) United States
(12) Patent Application Publication
(10) Pub. No.: US 2006/0191419 A1
(43) Pub. Date: Aug. 31, 2006

(54) Wine vessel system

(76) Inventors: Edward Storm Spoljaric, Pasadena, CA (US); David Chaum, Sherman Oaks, CA (US)

Correspondence Address: Edward Storm Spoljaric, 1329 Linda Vista Ave., Pasadena, CA, 91103, US

(21) Appl. No.: 11/364,679

(22) Filed: Feb. 28, 2006

Related U.S. Application Data
(60) Provisional application No. 60/656,937, filed on Feb. 28, 2005.

(51) Int. Cl. C12C 11/00

(52) U.S. Cl. 99/276

(57) ABSTRACT

In one example embodiment, an article of manufacture includes a wooden element such as a dowel, preferably formed from toasted oak, that is attached to the inside of a screw-type wine vessel closure. In a second example embodiment, the wooden element is attached to a stopper. In yet other embodiments, elements are attached to the inside of a wine bottle or are prevented from leaving the bottle during pouring by deformable shape. In a wine making method, the wine is not aged in oak barrels but rather filled in bottles and sealed with the oak insert and aged in the bottles, including optional agitation, to accomplish substantially the functions of the barrel oak aging.

### BACKGROUND OF THE INVENTION

1. Field of the Invention

The present invention relates generally to wine containers, and more specifically to wooden elements incorporated in wine vessels and methods of manufacture in such systems.

2. Description of Prior Art

Reference is hereby made to U.S. provisional application 60/656,937, dated Feb. 28, 2005 by the present applicant, that is hereby included in its entirety by reference and from which priority is claimed.

Screw-top wine bottles and synthetic stoppers are gaining popularity, including for the reason that they reduce spoilage. The lack of “tradition” appeal is, however, believed to be working against their adoption. At the same time, barrel processing of wine is becoming all the more costly.

Known in the art are wine bottles where a wooden element comes out through the pouring opening and is uncovered and exposed to air, such as those disclosed by Herzfeld in U.S. Pat. No. 3,942,423 and Nilsson in U.S. Pat. No. 2,203,229. One issue with such packaging proposals is that they are not sealed and thus subject to ongoing contamination in both directions. Another is that the surface area exposed may not be sufficient to provide adequate effect and that inefficient use is made of the wood elements and that they are difficult to manufacture.

The present invention aims, accordingly and among other things, to provide an alternative to barrel processing that enhances the “tradition” appeal of wine packaging. Objects of the invention also include addressing all the above mentioned as well as generally providing practical, robust, efficient, low-cost wine packaging. All manner of apparatus and methods to achieve any and all of the forgoing are also included among the objects of the present invention.

Other objects, features, and advantages of the invention will be appreciated when the present description and appended claims are read in conjunction with the drawing figurers.

### BRIEF DESCRIPTION OF THE DRAWING FIGURES

FIG. 1 is a combination schematic and sectional diagram of an exemplary embodiment wood stick attached to a screw top in accordance with the teachings of the present invention.

FIG. 2 is a combination schematic and sectional diagram of an exemplary embodiment wood stick cooperating with a stopper in accordance with the teachings of the present invention.

FIG. 3 is a combination schematic and sectional diagram of an exemplary embodiment wood strip cooperating with a vessel in accordance with the teachings of the present invention.

### BRIEF SUMMARY OF THE INVENTION

This section introduces some of the inventive concepts in a way that will readily be appreciated, but makes significant simplifications and omissions for clarity and should not be taken to limit their scope in any way; the next section presents a more general view.

In one example aspect, an article of manufacture includes a wooden element, preferably a toasted oak bar or strip, such as that used in aging wine, that is attached to the inside of a screw-type wine bottle closure so that the oak is substantially submerged in the beverage and removed with the closure. In a second example embodiment, the wooden element is attached to the inside of a stopper, such as a synthetic stopper. In a wine making method, as a substitute for all or part of the aging in oak barrels, wine is filled in bottles and then sealed with the oak element affixed to the inside of the closure means and aged in the bottles.

### GENERAL DESCRIPTION

In this invention, the type of vessel “closure” is preferably a screw type or a stopper, but the scope of the invention should not be limited to the type of closure. Screw caps are known to be formed from aluminum, for example, and stoppers from natural cork, composites including cork, and synthetics. Any means for keeping the beverage in the vessel will be considered a closure means.

The form of the wood element is in one preferred embodiment a dowel attached to the inside of a closure, but should not be limited in any way to this form. Any shape formed from one or more pieces of wood will be considered a wooden “element.” Examples include substantially thin sheets of wood cut from larger pieces by knives, such as in a relative rotary or linear motion. Composites including wood pieces or particles are also anticipated. As another illustrative example, automatic machinery is known for producing such things as toothpicks, skewers, and chopsticks, and such can be adapted.

In some example embodiments, the wooden element is not attached, but rather is at least substantially unlikely or unable to readily leave the vessel when the beverage is poured. Any means or method for accomplishing this is anticipated. As an example, the element is optionally formed as a shaving or veneer that is preferably spiral, such as owing to the angle of incident cutting edge, and that substantially expands in form once placed in the vessel so that it is not readily carried out with contents as they are poured out. In still another innovative aspect, the element is of a substantially thin form, such as a strip or ribbon, so that the amount of “oaking” that it yields is accomplished substantially to a large extent during an earlier period of time. It is also anticipated that swelling of the wood may occur during soaking in wine and that this will make the element larger and unable to retrace its entry into the bottle. Moreover, an element can be formed with a single or very limited number of positions needed to exit, but that will substantially tend at least with high probability to take other positions during pouring.

Attaching a wooden element to a closure is illustrated by press fitting and by adhesive or other material; however, any means or method whatsoever for ensuring that the wooden element remains mechanically associated with the closure means will be considered here as “attaching.” Attaching a wooden element to a vessel, as another example, is for instance by pushing a hole in a strip over a mushroom protrusion on the inside of the vessel and/or pressing part of an element into a cavity.

### DETAILED DESCRIPTION OF PREFERRED EMBODIMENTS

Detailed descriptions are presented here sufficient to allow those of skill in the art to use the exemplary preferred embodiments of the inventive concepts.

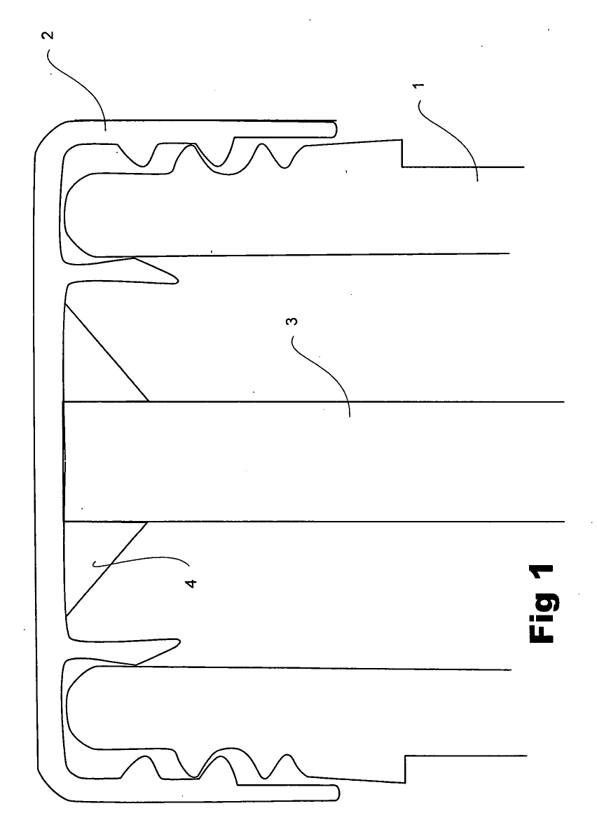

Turning now to FIG. 1, a combination schematic and sectional diagram of an exemplary embodiment wood stick attached to a screw top in accordance with the teachings of the present invention will now be described in sufficient detail to allow those of ordinary skill in the art to make and use it.

In the example shown, the bottle 1 has threads formed in its exterior to cooperate with the threads formed in cap 2, as is well known in the art. Wooden dowel, such as of ⅜″ diameter, is shown attached to lid 2 by adhesive holding compound filet 4. In an exemplary embodiment, filet 4 is from an FDA approved material and is cured during manufacture while dowel 3 is held in position by means not shown for clarity.

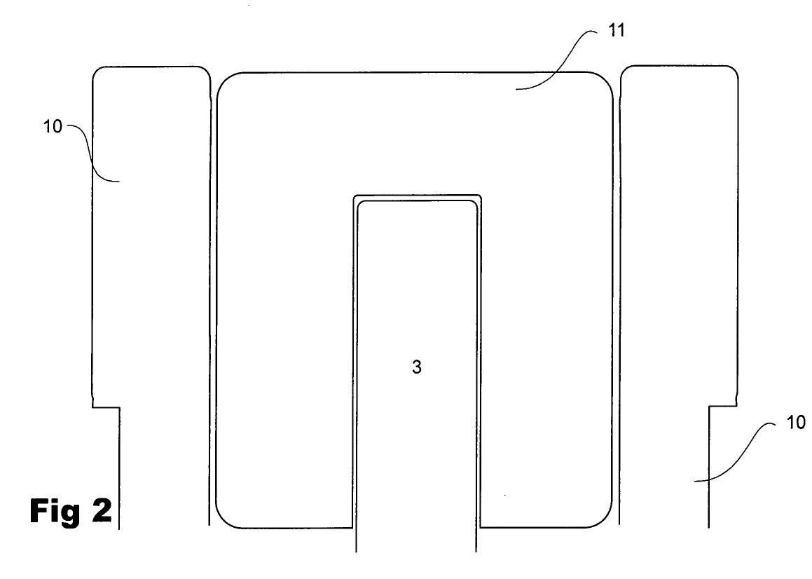

Turning to FIG. 2 a combination schematic and sectional diagram of an exemplary embodiment wood stick cooperating with a stopper in accordance with the teachings of the present invention will now be described in detail. The bottle 10 has no threads and is closed by closure means not detailed for clarity. Wooden dowel element 3 is shown pressed into stopper 11, which in turn is pressed into opening of bottle 10.

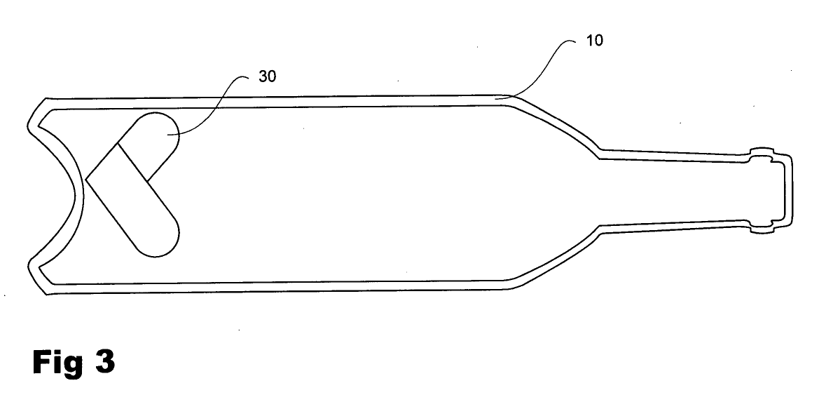

Turning finally to FIG. 3 a combination schematic and sectional diagram of an exemplary embodiment wood strip cooperating with vessel in accordance with the teachings of the present invention will now be described in detail. The bottle 10 is closed by whatever means. A strip or ribbon 3 of preferably toasted oak or other wood is shown in a folded or bent configuration. Other example configurations are spirals and/or whatever shape may be desired, such as from a marketing point of view. Such ribbons are, for example, formed by a block plane type of mechanism and it is believed that canting the blade with respect to the grain and direction of motion produces substantially spiral strips. Other example forming methods are known in the veneer art and include post cutting by die or laser cutting. Sheets are optionally toasted before ribbons are formed. During insertion into the bottle, the element is deformed so that it can be inserted; when opened for use, the element has preferably become saturated with wine and its mechanical properties altered. Forces on the element during pouring are preferably such that in its altered state it is not distorted sufficiently to come out with the wine.

Several other example embodiments are anticipated and not shown for clarity. The wooden element is not attached to the closure in some embodiments, but instead the wooden element is attached to the inside of the vessel. In yet another optional embodiment, the wooden element performs the function of a patch on the side of the vessel, exposed to beverage on the inside and air on the outside, and held in place by pressure and/or sealant such as wax; providing a recess on the inside of the vessel to receive the element allows it to be held against positive pressure after being inserted through the hole lengthwise and then oriented to substantially conform to the provided receiving form.

All manner of variations, modifications, equivalents, substitutions, simplifications, extensions, and so forth can readily be conceived relative to the present inventions by those of ordinary skill in the art. One example, as will be ppreciated, is that the dowel will have a fluted and/or otherwise textured or relieved surface to increase the amount of contact area and/or for aesthetic reasons. In another example, modification to the bottling machinery design is believed facilitated by partly including the wooden element in the vessel before affixing the closure, so that the range of motion of the mechanism that attaches the closure to the vessel is reduced.

While these descriptions of the present invention have been given as examples, it will be appreciated by those of ordinary skill in the art that various modifications, alternate configurations and equivalents may be employed without departing from the spirit and scope of the present invention.

What is claimed is:

1. An article of manufacture comprising:
a wine vessel closure with an attached wooden element such that the closure substantially seals the element within the vessel.

2. In the article of claim 1,
a wooden dowel inserted into a stopper.

3. In the article of claim 1,
a wooden dowel affixed to a screw cap.

4. An article of manufacture comprising:
a wine bottle with a contained wood element that is substantially prevented from leaving the bottle during pouring.

5. In the article of claim 4,
the wooden element being a substantially formed to allow insertion into the vessel but obtaining a later form substantially as to prevent ready exit during pouring.

6. In the article of claim 4,
the wooden element being affixed to the inside of the bottle and not exposed to the outside of the bottle.

7. In the article of claim 4,
the wooden element being substantially affixed to the inside of the bottle and exposed to the wine and also exposed to the outside of the bottle and held in place including by sealing means.

8. A beverage making method, including the steps of:
filling a vessel with beverage and including at least some wood in the vessel in such a way that the wood at least substantially is unlikely to leave the vessel during normal pouring of the contained beverage.

9. In the method of claim 8,
attaching the wooden element to the closure,
filling the vessel with beverage. and
attaching the closure to the bottle.

10. In the method of claim 8,
attaching the wooden element to the closure while the element is substantially at least partly in the vessel.

11. In the method of claim 8,
inserting the wooden element into the vessel before processing by standard bottling equipment.
